(19) United States
(12) Patent Application Publication
(10) Pub. No.: US 2025/0242183 A1
(43) Pub. Date: Jul. 31, 2025

(54) FIRE SUPPRESSION SYSTEM FOR AUTOMATIC TRACKING OF IGNITION POINT

(71) Applicant: HYUNDAI INFRACORE Co., Ltd, Seoul (KR)

(72) Inventors: Taehoon KIM, Seoul (KR); Youngbock SHIM, Seoul (KR)

(21) Appl. No.: 19/042,210

(22) Filed: Jan. 31, 2025

(30) Foreign Application Priority Data
Jan. 31, 2024 (KR) 10-2024-0014862

(51) Int. Cl. A62C 37/11

(52) U.S. Cl. CPC A62C 37/11

(57) ABSTRACT

A fire suppression system for automatically tracking an ignition point comprises a fire extinguishing agent spraying module comprising: a casing installed to be rotatable in a horizontal direction in a monitoring target area; and an ejection nozzle installed on the casing to be pivotable in a vertical direction and configured to eject a fire extinguishing agent to a fire occurrence point in the monitoring target area; an automatic ignition point tracking detection module disposed close to the ejection nozzle and configured to detect whether a fire has occurred in the monitoring target area and to calculate coordinates of an ignition point; and a controller configured to rotate the casing and pivot the ejection nozzle based on the coordinates of the ignition point calculated by the automatic ignition point tracking detection module, and ejects the fire extinguishing agent to the ignition point.

### CROSS-REFERENCE TO RELATED APPLICATION

This application claims priority from Korean Patent Application No. 10-2024-0014862 filed on Jan. 31, 2024, in the Korean Intellectual Property Office, and all the benefits accruing therefrom under 35 U.S.C. 119, the contents of which in its entirety are herein incorporated by reference.

### BACKGROUND

### Field

The present disclosure relates to a fire suppression system for automatically tracking an ignition point and, more specifically, to a fire suppression system for automatically tracking an ignition point, which can detect whether a fire occurs in a monitoring target area in real time and track an ignition point and ejects a fire extinguishing agent toward the ignition point to suppress a fire.

### Description of Related Art

In general, in various buildings such as most of facilities or buildings, fire suppression devices such as sprinklers and fire shutters are installed in order to quickly respond to a fire and protect property and life.

In the case of the sprinkler as described above, the soluble metal of the head thereof is dissolved due to an abnormal high temperature caused by the occurrence of a fire such that the fire extinguishing water is automatically sprayed to extinguish the fire. However, the abnormal high temperature caused by the occurrence of the fire is not transferred to the sprinkler installed on the indoor ceiling at the beginning of the occurrence of the fire, such that the fire cannot be extinguished. At the time when the fire extinguishing water is sprayed through the sprinkler, the fire has already propagated for a considerable time such that the fire is extinguished in a state in which the damage caused by the fire is very large.

Accordingly, recently, a smart fire suppression device that detects a fire in an automated manner and repeatedly operates until the fire is extinguished by spraying water or a fire extinguishing liquid has been introduced. However, the above fire suppression devices only employ a technology of simply detecting a fire occurrence, detecting a fire area, and controlling a fire extinguishing unit to spray the fire extinguishing water to the fire area, and there is no suggestion of a scheme capable of accurately identifying whether the fire event detected by a fire detection unit is a real fire event, tracking a point of ignition, and spraying a fire extinguishing agent toward the point of ignition at an initial stage of the fire, thereby quickly suppressing the fire.

[Prior Art] Korean Patent Registration No. 10-2236901 (2021.03.31)

### SUMMARY

A purpose of the present disclosure is to provide a fire suppression system for automatically tracking an ignition point, which monitors and tracks the occurrence of a fire in a monitoring target area in real time, and accurately aims at and sprays a fire extinguishing agent toward an ignition point in the initial stage of the fire, thereby suppressing the fire generated in the monitoring target area in the shortest time in the initial stage.

Purposes according to the present disclosure are not limited to the above-mentioned purpose. Other purposes and advantages according to the present disclosure that are not mentioned may be understood based on following descriptions and may be more clearly understood based on embodiments according to the present disclosure. Further, it will be easily understood that the purposes and advantages according to the present disclosure may be realized using means shown in the claims or combinations thereof.

In order to achieve the above purpose, the present disclosure provides a fire suppression system for automatically tracking an ignition point, the system comprising: a fire extinguishing agent spraying module comprising: a casing installed to be rotatable in a horizontal direction in a monitoring target area; and an ejection nozzle installed on the casing to be pivotable in a vertical direction and configured to eject a fire extinguishing agent to a fire occurrence point in the monitoring target area; an automatic ignition point tracking detection module disposed close to the ejection nozzle and configured to detect whether a fire has occurred in the monitoring target area and to calculate coordinates of an ignition point; and a controller configured to rotate the casing and pivot the ejection nozzle based on the coordinates of the ignition point calculated by the automatic ignition point tracking detection module such that the ejection nozzle may be directed toward the ignition point, and ejects the fire extinguishing agent to the ignition point.

In accordance with some embodiments of the fire suppression system for automatically tracking the ignition point, the casing may be rotatable in the horizontal direction by a first driving motor controlled by the controller, wherein the ejection nozzle may be pivotable in the vertical direction by a second driving motor controlled by the controller and may be configured to eject the fire extinguishing agent, wherein the fire extinguishing agent spraying module may further comprise: a fire extinguishing agent storage tank connected to the ejection nozzle via a fire extinguishing agent supply line and configured to supply the fire extinguishing agent stored therein to the ejection nozzle via the fire extinguishing agent supply line; and an opening and closing valve installed at the fire extinguishing agent supply line, wherein when a fire occurrence signal may be transmitted from the automatic ignition point tracking detection module to the controller, the opening and closing valve may be configured to be opened by the controller such that the fire extinguishing agent stored in the fire extinguishing agent storage tank may be fed to the ejection nozzle via the fire extinguishing agent supply line and then may be ejected to the ignition point through the ejection nozzle.

In accordance with some embodiments of the fire suppression system for automatically tracking the ignition point, the automatic ignition point tracking detection module may comprise: an ultraviolet-ray (UV) sensor disposed close to the ejection nozzle and configured to detect ultraviolet rays emitted from a flame in the monitoring target area and to transmit a fire detection signal to a controller; first and second infrared-ray sensors configured to detect infrared rays generated from the flame when the fire detection signal has been transmitted from the ultraviolet-ray sensor to the controller, to detect whether a fire has occurred in the monitoring target area in a double manner based on the detected infrared rays, and to detect an infrared detection position based on the detected infrared rays; an ignition point coordinate calculator configured to calculate coordinates of the ignition point based on the infrared detection position detected from the first and second infrared-ray sensors and to transmit the calculated coordinates to the controller, wherein the controller may be configured to rotate the casing and pivot the ejection nozzle based on the coordinates of the ignition point such that the ejection nozzle may be directed toward the ignition point; and a thermal imaging camera disposed close to the ejection nozzle and configured to acquire a thermal image of the monitoring target area, to measure a temperature of the monitoring target area, and to detect whether a fire has occurred in the monitoring target area, based on the measured temperature.

In accordance with some embodiments of the fire suppression system for automatically tracking the ignition point, when the casing and the ejection nozzle of the fire extinguishing agent spraying module are respectively rotated and pivoted based on the coordinates of the ignition point as calculated by the ignition point coordinate calculator such that the ejection nozzle is directed toward the ignition point, the thermal imaging camera may be configured to: acquire a thermal image of the ignition point; and only upon determination that the temperature of the ignition point in the thermal image is higher than or equal to a threshold temperature, determine that the fire may be a real fire, and transmit a fire extinguishing agent ejection signal to the controller.

In accordance with some embodiments of the fire suppression system for automatically tracking the ignition point, when a temperature of the ignition point in the obtained thermal image of the monitoring target area is higher than or equal to a threshold temperature in a state in which a fire is not sensed by the ultraviolet-ray sensor and the first and second infrared-ray sensors, the thermal imaging camera may be configured to calculate coordinates of the ignition point and transmit the calculated coordinates to the controller, wherein the controller may be configured to rotate the casing and pivot the ejection nozzle based on the coordinates of the ignition point such that the ejection nozzle may be directed toward the ignition point and eject the fire extinguishing agent to the ignition point.

In accordance with some embodiments of the fire suppression system for automatically tracking the ignition point, the automatic ignition point tracking detection module may further comprise an artificial intelligence (AI) camera disposed close to the ejection nozzle and configured to acquire a real image of the monitoring target area and to detect whether a fire has occurred in the monitoring target area based on the real image.

In accordance with some embodiments of the fire suppression system for automatically tracking the ignition point, when a temperature of the ignition point in the obtained thermal image of the monitoring target area is higher than or equal to a threshold temperature in a state in which a fire is not sensed by the ultraviolet-ray sensor and the first and second infrared-ray sensors, the AI camera may be configured to: acquire a real image of the ignition point, determine whether a fire may be a real fire based on the real image; and upon determination that the real fire has occurred, calculate coordinates of the ignition point are and transmit the calculated coordinates to the controller, wherein when the coordinates of the ignition point is transmitted from the AI camera to the controller, the controller may be configured to operate the ultraviolet-ray sensor and the first and second infrared-ray sensors to re-detect whether a fire has occurred at the ignition point, wherein the infrared detection position detected as the first and second infrared-ray sensors operates may be transmitted to the ignition point coordinate calculator, wherein the ignition point coordinate calculator may be configured to recalculate the ignition point coordinates, and transmit the recalculated ignition point coordinates to the controller, wherein the controller may be configured to rotate the casing and pivot the ejection nozzle based on the recalculated ignition point coordinates to direct the ejection nozzle toward the ignition point, wherein the thermal imaging camera may be configured to re-acquire a thermal image of a monitoring target area, re-measure a temperature of the ignition point, determine the fire as a real fire only when the temperature of the ignition point is higher than or equal to a threshold temperature, and transmit a fire extinguishing agent ejection signal to the controller upon determination that the fire is the real fire, wherein the controller controls the ejection nozzle to eject the fire extinguishing agent to the ignition point in response to the fire extinguishing agent ejection signal.

In accordance with some embodiments of the fire suppression system for automatically tracking the ignition point, when a fire is detected based on the real image of the monitoring target area obtained by the AI camera in a state in which a fire is not detected by the ultraviolet-ray sensor, the first and second infrared-ray sensors, and the thermal imaging camera, the AI camera may be configured to: analyze the real image of the ignition point and determine whether the fire is a real fire based on the analysis result; upon determination that the real fire has occurred, calculate coordinates of the ignition point and transmit the calculated coordinates to the controller, wherein when the coordinates of the ignition point is transmitted from the AI camera to the controller, the controller may be configured to operate the ultraviolet-ray sensor and the first and second infrared-ray sensors to re-detect whether a fire has occurred at the ignition point, wherein the infrared detection position detected as the first and second infrared-ray sensors operates may be transmitted to the ignition point coordinate calculator, wherein the ignition point coordinate calculator may be configured to calculate the ignition point coordinates, and transmit the calculated ignition point coordinates to the controller, wherein the controller may be configured to rotate the casing and pivot the ejection nozzle based on the calculated ignition point coordinates to direct the ejection nozzle toward the ignition point, wherein the thermal imaging camera may be configured to re-acquire a thermal image of a monitoring target area, re-measure a temperature of the ignition point, determine the fire as a real fire only when the temperature of the ignition point is higher than or equal to a threshold temperature, and transmit a fire extinguishing agent ejection signal to the controller upon determination that the fire is the real fire, wherein the controller controls the ejection nozzle to eject the fire extinguishing agent to the ignition point in response to the fire extinguishing agent ejection signal.

In accordance with some embodiments of the fire suppression system for automatically tracking the ignition point, upon determination that a distance from the ejection nozzle to the ignition point is within a preset distance, the controller may be configured to control the ejection nozzle to spray the fire extinguishing agent to the ignition point in a shower manner, wherein upon determination that the distance from the ejection nozzle to the ignition point is out of the preset distance, the controller may be configured to control the ejection nozzle to eject the fire extinguishing agent to the ignition point in a shooting manner.

In accordance with some embodiments of the fire suppression system for automatically tracking the ignition point, the automatic ignition point tracking detection module may further comprise a dust-proof means configured to periodically operate every time interval set by the controller to remove dusts accumulated on a surface of each of the ultraviolet-ray sensor and the first and second infrared-ray sensors and a lens of each of the thermal imaging camera and the AI camera.

As described above, the fire suppression system for automatically tracking an ignition point according to an embodiment of the present disclosure detects whether a fire has occurred in a monitoring target area in real time using the automatic ignition point tracking detection module, tracks the ignition point, and quickly and accurately determines whether a real fire has occurred at the detected ignition point, and ejects the fire extinguishing agent to the ignition point in an accurate manner, thereby quickly suppressing the fire in the early stage.

In addition, the fire suppression system for automatically tracking an ignition point according to an embodiment of the present disclosure is capable of detecting the fire occurrence in the monitoring target area in a multiple checking manner in response to various initial fire occurrence conditions. Thus, even at the beginning of the fire occurrence at which it is difficult to detect the fire occurrence, the ignition point is quickly and accurately detected and tracked. Thus, when it is determined that the real fire has occurred, the ejection nozzle is accurately directed to the ignition point and ejects the fire extinguishing agent thereto, thereby being capable of quickly suppressing the fire in the early stages of the fire.

Therefore, the fire suppression system for automatically tracking an ignition point according to an embodiment of the present disclosure not only very quickly and accurately detects whether the real fire has occurred in the monitoring target area at the beginning of the fire event, but also tracks the ignition point in real time. Thus, when it is determined that the fire is the real fire based on the tracking result, the fire at the ignition point can be suppressed in the shortest time, thereby preventing the fire occurring in the monitoring target area from increasing to the large fire, thereby significantly improving the reliability and safety of the fire detection and the fire suppression, and minimizing casualties and property damage caused by the fire occurrence.

In addition, the effects of the present disclosure will be clearly understood by experts or researchers in the technical field based on the detailed contents as described below or during the process of implementing the present disclosure.

Thus, the effects of the present disclosure are not limited to the effects mentioned above, and other effects not mentioned will be clearly understood by those skilled in the art from the description below.

### BRIEF DESCRIPTION OF DRAWINGS

FIG. 1 is a view illustrating a state in which a fire suppression system for automatically tracking an ignition point according to an embodiment of the present disclosure is installed.

FIG. 2 is a view illustrating a state in which an automatic ignition point tracking detection module is disposed in a fire extinguishing agent spraying module.

FIG. 3 is a block diagram for illustrating a fire suppression system for automatically tracking an ignition point according to an embodiment of the present disclosure.

FIG. 4 is a flowchart illustrating a process of suppressing a fire when ultraviolet rays emitted from a flame in a monitoring target area are detected by an ultraviolet-ray sensor.

FIG. 5 is a flowchart illustrating a process of suppressing a fire when a fire in a monitoring target area is detected by an AI camera.

FIG. 6 is a flowchart for illustrating a process of suppressing a fire when a fire in a monitoring target area is detected by a thermal imaging camera.

FIG. 7 is another flowchart for illustrating a process of suppressing a fire when a fire is detected in a monitoring target area by a thermal imaging camera.

### DETAILED DESCRIPTIONS

Advantages and features of the present disclosure, and a method of achieving the advantages and features will become apparent with reference to embodiments described below in detail together with the accompanying drawings. However, the present disclosure is not limited to the embodiments as disclosed under but may be implemented in various different forms. Thus, these embodiments are set forth only to make the present disclosure complete, and to entirely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for illustrating embodiments of the present disclosure are illustrative, and the present disclosure is not limited thereto.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items.

In addition, it will also be understood that when a first element or layer is referred to as being present “on” a second element or layer, the first element may be disposed directly on the second element or may be disposed indirectly on the second element with a third element or layer being disposed between the first and second elements or layers. It will be understood that when a first element or layer is referred to as being “connected to”, or “coupled to” a second element or layer, the first element may be directly connected to or coupled to the second element or layer, or one or more intervening elements or layers may be present therebetween. In addition, it will also be understood that when an element or layer is referred to as being “between” two elements or layers, it may be the only element or layer between the two elements or layers, or one or more intervening elements or layers may also be present therebetween.

In descriptions of temporal relationships, for example, temporal precedent relationships between two events such as “after”, “subsequent to”, “before”, etc., another event may occur therebetween unless “directly after”, “directly subsequent” or “directly before” is not indicated.

When a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

It will be understood that, although the terms “first”, “second”, “third”, and so on may be used herein to describe various elements, components, regions, layers and/or periods, these elements, components, regions, layers and/or periods should not be limited by these terms. These terms are used to distinguish one element, component, region, layer or section from another element, component, region, layer or section. Thus, a first element, component, region, layer or section as described under could be termed a second element, component, region, layer or section, without departing from the spirit and scope of the present disclosure.

When an embodiment may be implemented differently, functions or operations specified within a specific block may be performed in a different order from an order specified in a flowchart. For example, two consecutive blocks may actually be performed substantially simultaneously, or the blocks may be performed in a reverse order depending on related functions or operations.

The features of the various embodiments of the present disclosure may be partially or entirely combined with each other, and may be technically associated with each other or operate with each other. The embodiments may be implemented independently of each other and may be implemented together in an association relationship.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present disclosure will be described in more detail with reference to the drawings.

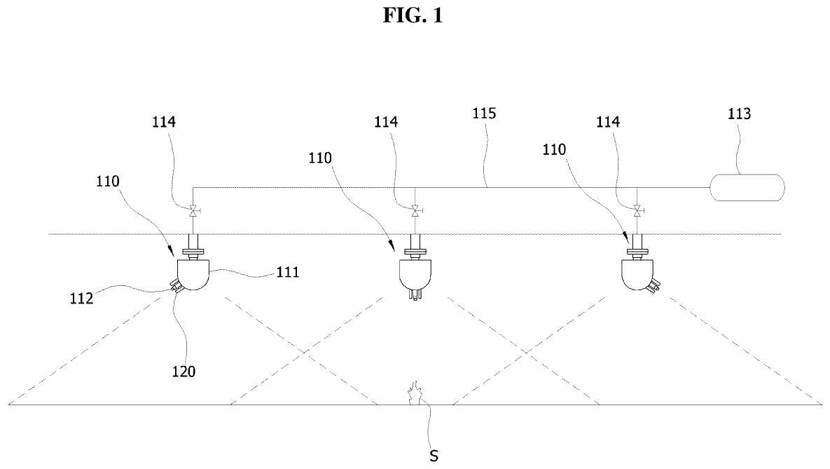

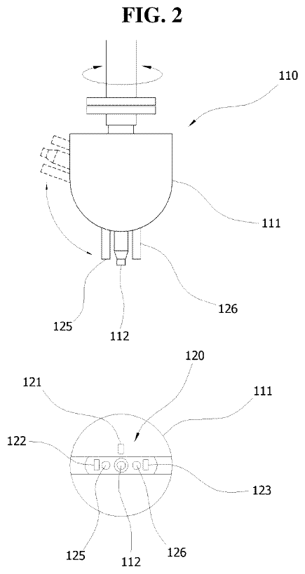

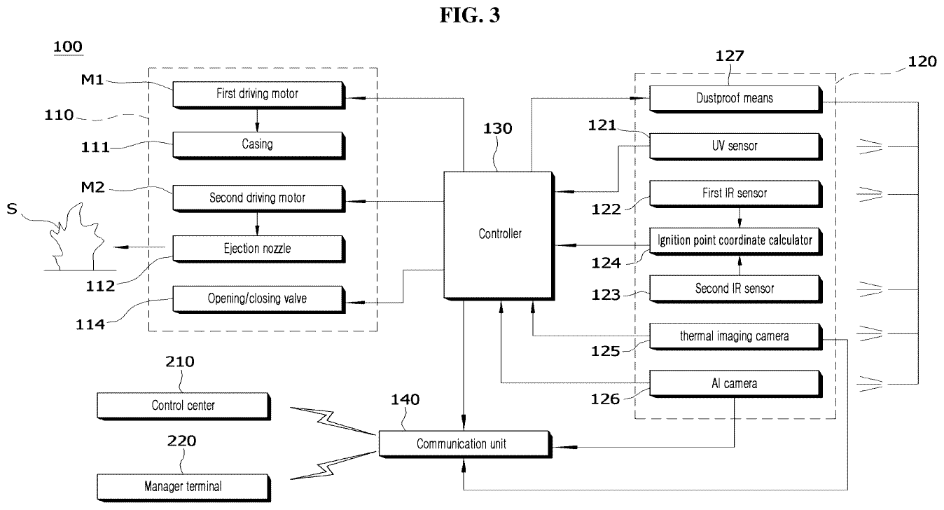

FIG. 1 is a view illustrating a state in which a fire suppression system for automatically tracking an ignition point according to an embodiment of the present disclosure is installed, FIG. 2 is a view illustrating a state in which a detection module for automatically tracking an ignition point is disposed in a fire extinguishing agent spraying module, and FIG. 3 is a block diagram for illustrating a fire suppression system for automatically tracking an ignition point according to an embodiment of the present disclosure.

Referring to FIGS. 1 to 3, a fire suppression system 100 for automatically tracking an ignition point according to an embodiment of the present disclosure may include a fire extinguishing agent spraying module 110, an automatic ignition point tracking detection module 120, and a controller 130.

The fire extinguishing agent spraying module 110 includes a casing 111 installed to be rotatable in a horizontal direction in the monitoring target area, and an ejection nozzle 112 capable of spraying the fire extinguishing agent to a fire occurrence point in the monitoring target area may be installed to be pivotable in a vertical direction on the casing 111.

In this regard, a plurality of fire extinguishing agent spraying modules 110 may be installed to be spaced apart from each other by a predetermined spacing. Adjacent fire extinguishing agent spraying modules 110 may be installed to be spaced apart from each other by a predetermined spacing so that corresponding neighboring monitoring target zones which the adjacent fire extinguishing agent spraying modules 110 are capable of spraying fire extinguishing agents, respectively, overlap each other by a predetermined area. For example, the fire extinguishing agent spraying module 110 may include the casing 111, the ejection nozzle 112, a fire extinguishing agent storage tank 113, and an opening/closing valve 114.

The casing 111 may be installed in a corresponding manner to the corresponding monitoring target area so as to be rotatable in the horizontal direction by a first driving motor M1 controlled by the controller 130.

In this regard, the first driving motor M1 periodically operates every time interval set by the controller 130 to rotate the casing 111 by a predetermined angle such that the automatic ignition point tracking detection module 120 installed on the casing 111 detects whether a fire has occurred in the monitoring target area.

The ejection nozzle 112 is installed on the casing 111 so as to be pivotable in the vertical direction by a second driving motor M2 controlled by the controller 130 to allow the fire extinguishing agent to be sprayed to an ignition point S.

In this regard, the ejection nozzle 112 is manufactured to adjust the ejection form of the fire extinguishing agent into a shower form and a shoot form. The ejection form of the fire extinguishing agent may be controlled by the controller based on a distance from the ejection nozzle 112 to the ignition point.

For example, when it is determined that the ignition point S is located within a set distance from the ejection nozzle 112, the controller 130 controls the ejection nozzle 112 to spray the fire extinguishing agent toward the ignition point S in a form of a shower. When it is determined that the ignition point S exceeds the set distance from the ejection nozzle 112, the controller controls the ejection nozzle S to shoot the fire extinguishing agent toward the ignition point S.

The fire extinguishing agent storage tank 113 is connected to the ejection nozzle 112 via a fire extinguishing agent supply line 115 and is configured to supply the fire extinguishing agent stored therein to the ejection nozzle 112 via the fire extinguishing agent supply line 115.

The opening/closing valve 114 may be controlled to be opened by the controller 130 when a fire occurrence signal is transmitted from the automatic ignition point tracking detection module 120 to the controller 130. The opening/closing valve 114 may be installed at the fire extinguishing agent supply line 115 and may discharge the fire extinguishing agent stored in the fire extinguishing agent storage tank 113 to the ignition point through the ejection nozzle 112 via the fire extinguishing agent supply line 115.

Each automatic ignition point tracking detection module 120 may be installed on each fire extinguishing agent spraying module 110 so as to be disposed close to the ejection nozzle 112 and may be configured to detect whether a fire has occurred in the monitoring target area, calculate the coordinates of the ignition point S, and transmit the coordinates to the controller 130.

For example, the automatic ignition point tracking detection module 120 may include an ultraviolet-ray sensor 121, first and second infrared-ray sensors 122 and 123, an ignition point coordinate calculator 124, and a thermal imaging camera 125.

The ultraviolet-ray sensor 121 is installed on the casing 111 so as to be disposed close to the ejection nozzle 112 and is configured to detect ultraviolet rays emitted from the flame in the monitoring target area and transmit a fire detection signal to the controller 130.

When the fire detection signal has been transmitted from the ultraviolet-ray sensor 121 to the controller 130, the first and second infrared-ray sensors 122 and 123 may detect infrared rays generated from the flame and double detect whether a fire has occurred, and, further, detect an infrared detection position and transmit the detected infrared detection position to the ignition point coordinate calculator 124.

For example, the first infrared-ray sensor 122 may detect an infrared detection position in a horizontal direction and transmit the detected position to the ignition point coordinate calculator 124, while the second infrared-ray sensor 123 may detect an infrared detection position in a vertical direction and transmit the detected position to the ignition point coordinate calculator 124.

The ignition point coordinate calculator 124 calculates the X-axis and Y-axis coordinates of the ignition point S based on the infrared detection positions in the horizontal and vertical directions detected from the first and second infrared-ray sensors 122 and 123 and transmits the calculated coordinates to the controller 130.

In one example, when the X-axis and Y-axis coordinates of the ignition point S are transmitted from the ignition point coordinate calculator 124 to the controller 13-, the controller 130 rotates the casing 111 in the horizontal direction based on the X-axis coordinate of the ignition point S, and pivots the ejection nozzle 112 in the vertical direction based on the Y-axis coordinate of the ignition point S, thereby directing the ejection nozzle 112 toward the ignition point S.

The thermal imaging camera 125 is disposed close to the ejection nozzle 112 and is configured to obtain a thermal image of the monitoring target area and measure a temperature thereof, such that the controller detects whether a fire has occurred in the monitoring target area.

The controller 130 rotates the casing 111 of the fire extinguishing agent spraying module 110 and pivots the ejection nozzle 112 of the fire extinguishing agent spraying module 110 based on the coordinates of the ignition point S as calculated by the ignition point coordinate calculator 124 such that the ejection nozzle 112 is directed toward the ignition point S and then ejects the fire extinguishing agent to the ignition point S.

In one example, when the casing 111 and the ejection nozzle 112 of the fire extinguishing agent spraying module 110 have been rotated and pivoted based on the coordinates of the ignition point S as calculated by the ignition point coordinate calculator 124 based on the detection results from the first and second infrared-ray sensors 122 and 123 such that the ejection nozzle 112 has been directed toward the ignition point S, the thermal imaging camera 125 acquires a thermal image of the ignition point S. Then, only when the temperature of the ignition point S is detected to be equal to or higher than a threshold temperature, and this event is determined as a real fire event, the thermal imaging camera 125 transmits a fire extinguishing agent ejection signal to the controller 130. In response thereto, the opening/closing valve 114 of the fire extinguishing agent spraying module 110 is opened by the controller 130 such that the ejection nozzle 12 ejects the fire extinguishing agent to the ignition point S.

That is, in accordance with the fire suppression system 100 for automatically tracking an ignition point according to some embodiments of the present disclosure, although the occurrence of the fire in the monitoring target area is detected by the ultraviolet-ray sensor 121 and the first and second infrared-ray sensors 122 and 123, and thus, the casing 111 and the ejection nozzle 112 of the fire extinguishing agent spraying module 110 are rotated and pivoted based on the coordinates of the ignition point S as calculated by the ignition point calculator coordinate calculator 124 based on the detection results from the first and second infrared-ray sensors 122 and 123 so that the ejection nozzle 112 is directed toward the ignition point S, it is determined that no fire has occurred in the monitoring target area upon determination that the ignition temperature of the ignition point S in the thermal image of the ignition point S obtained by the thermal imaging camera 125 is not higher than the threshold temperature. To the contrary, it is determined that the fire is a real fire only when the temperature of the ignition point S in the thermal image of the ignition point S obtained by the thermal imaging camera 125 is higher than the threshold temperature. Thus, the fire extinguishing agent ejection signal is transmitted from the thermal imaging camera 125 to the controller 130 so that the fire extinguishing agent spraying module 110 is controlled by the controller 130 to eject the fire extinguishing agent to the ignition point S through the ejection nozzle 112.

In addition, even though the ultraviolet rays emitted from the flame are not sensed by the ultraviolet-ray sensor 121 and infrared rays generated from the flame are not sensed by the first and second infrared-ray sensors 122 and 123, the sensed temperature of the ignition point S in the thermal image of the monitoring target area obtained by the thermal imaging camera 125 is higher than the threshold temperature. In this case, the ignition point calculator coordinate calculator 124 calculates the coordinates of the ignition point S and transmits the calculated coordinates to the controller 130.

In this regard, when the coordinates of the ignition point S is transmitted from the thermal imaging camera 125 to the controller 130, the controller 130 determines that a fire has occurred in the monitoring target area, and at the same time, rotates the casing 111 in a horizontal direction based on the coordinates of the ignition point S from the ignition point calculator coordinate calculator 124 and pivots the ejection nozzle 112 in a vertical direction based on the coordinates of the ignition point S from the ignition point calculator coordinate calculator 124 such that the ejection nozzle 112 is directed toward the ignition point S. Then. The controller 130 opens the opening/closing valve 114 to allow the fire extinguishing agent to be ejected to the ignition point S through the ejection nozzle 112.

In addition, the automatic ignition point tracking detection module 120 may further include an AI camera 126.

The AI camera 126 is installed on the casing 111 so as to be disposed close to the ejection nozzle 112 and is configured to obtain an image in the monitoring target area and detect whether a fire has occurred in the monitoring target area based on a real image.

In this regard, in a state in which the UV ray and the infrared ray generated from the flame are not sensed by the ultraviolet-ray sensor 121 and the first and second infrared-ray sensors 122 and 123, and the temperature of the ignition point S in the thermal image of the monitoring target area sensed by the thermal imaging camera 125 is not higher than or equal to the threshold temperature, the AI camera 126 may detect the fire in the monitoring target area based on the obtained real image thereof. In this case, the AI camera 126 may acquire and analyze the real image of the ignition point S and determine whether the real fire has occurred therein, based on the analysis result. When it is determined that the real fire has occurred, the AI camera 126 calculates the coordinates of the ignition point S and transmits the calculated coordinates to the controller 130.

When the coordinates of the ignition point S calculated from the AI camera 126 has been transmitted to the controller 130, the controller 130 operates the ultraviolet-ray sensor 121 and the first and second infrared-ray sensors 122 and 123 to re-detect whether the real fire has occurred at the ignition point S.

In addition, the infrared detection position detected when the first and second infrared-ray sensors 122 and 123 operate is transmitted to the ignition point coordinate calculator 124 which in turn re-calculates the coordinates of the ignition point S and transmits the re-calculated coordinates to the controller 130. In response thereto, the controller 130 rotates the casing 111 and pivots the ejection nozzle 112 based on the re-calculated coordinates of the ignition point S to direct the ejection nozzle 112 toward the ignition point S.

Thereafter, the thermal imaging camera 125 re-acquires the thermal image of the monitoring target area, re-measures the temperature at the ignition point S, determines that the fire is the real fire only when the sensed temperature at the ignition point S is equal to or higher than the threshold temperature. Then, upon determination that the fire is the real fire, the thermal imaging camera 125 transmits the fire extinguishing agent ejection signal to the controller 130, so that the opening/closing valve 114 is opened by the controller 130. Thus, the fire extinguishing agent is ejected to the ignition point S through the ejection nozzle 112.

In addition, in a state in which the ultraviolet ray emitted from the flame is not detected by the ultraviolet ray sensor 121, the infrared rays generated from the flame are not detected by the first and second infrared ray sensors 122 and 123, and the temperature as detected in the thermal image obtained by the thermal image camera 125 is not higher than or equal to the threshold temperature such that the fire is not detected, the AI camera 126 may detect the fire based on the real image of the monitoring target area sensed by the AI camera 126. In this case, the AI camera 126 analyzes the real image of the ignition point S and determines whether the real fire has occurred based on the analysis result. When it is determined that the real fire has occurred, the coordinates of the ignition point S calculated by the AI camera 126 is transmitted therefrom to the controller 130.

When the coordinates of the ignition point as calculated by the AI camera 126 has been transmitted from the AI camera 126 to the controller 130, the controller 130 operates the ultraviolet-ray sensor 121 and the first and second infrared-ray sensors 122 and 123 to re-detect whether the fire has occurred at the ignition point S.

In addition, the infrared detection position detected as the first and second infrared-ray sensors 122 and 123 operate is transmitted to the ignition point coordinate calculator 124 which in turn re-calculates the coordinates of the ignition point S and transmits the re-calculated coordinates to the controller 130. In response thereto, the controller 130 rotates the casing 111 and pivots the ejection nozzle 112 based on the re-calculated coordinates of the ignition point S to direct the ejection nozzle 112 toward the ignition point S.

Thereafter, the thermal imaging camera 125 re-acquires the thermal image of the monitoring target area, re-measures the temperature of the ignition point S, determines that the fire is a real fire only when the temperature of the ignition point S sensed in the thermal image is higher than the threshold temperature. Upon determination that the fire is the real fire, the thermal imaging camera 125 transmits the fire extinguishing agent ejection signal to the controller 130, so that the opening/closing valve 114 is opened by the controller 130. Thus, the fire extinguishing agent is ejected to the ignition point S through the ejection nozzle 112.

In addition, the automatic ignition point tracking detection module 120 may further include a dustproof means 127 that periodically operates every time interval set by the controller 130 to remove dust accumulated on the surfaces of the ultraviolet-ray sensor 121, the first and second infrared-ray sensors 122 and 123, the thermal imaging camera 125, and the AI camera lens 126.

For example, the dustproof means 127 may be an air spray nozzle that periodically operates every time interval set by the controller 130 under control of the controller 130 to spray air onto the surfaces of the ultraviolet-ray sensor 121 and the first and second infrared-ray sensors 122 and 123, and the lenses of the thermal imaging camera 125 and the AI camera 126 to remove the dust therefrom.

As described above, in the fire suppression system 100 for automatically tracking an ignition point according to an embodiment of the present disclosure, the dustproof means 127 periodically removes the dusts accumulated on the surfaces of the ultraviolet-ray sensor 121, the first and second infrared-ray sensors 122 and 123, the thermal imaging camera 125, and the AI camera lens 126 for detecting whether the fire has occurred, thereby preventing the ultraviolet-ray sensor 121, the first and second infrared-ray sensors 122 and 123, the thermal imaging camera 125, and the AI camera 126 from not operating in the event of the fire.

In one example, it is preferable that the waterproof and dustproof functions may be added to the ultraviolet-ray sensor 121, the first and second infrared-ray sensors 122 and 123, the thermal imaging camera 125, and the AI camera 126.

In addition, the fire suppression system 100 for automatically tracking an ignition point according to an embodiment of the present disclosure may further include a communication unit 140 capable of transmitting a fire detection signal or a danger detection signal from the controller 130 to a control center 210 or a manager terminal 220 through wireless communication.

Referring to FIGS. 1 to 7, a process of detecting and suppressing a fire in a monitoring target area using the fire suppression system for automatically tracking an ignition point according to an embodiment of the present disclosure and an operation effect thereof will be described.

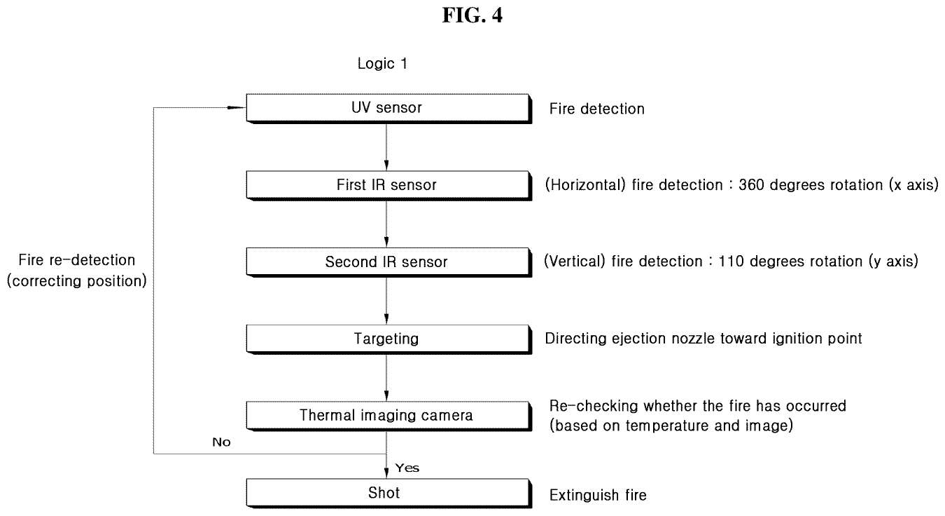

FIG. 4 is a flowchart illustrating a process of suppressing a fire when ultraviolet rays emitted from a flame in a monitoring target area are detected by an ultraviolet-ray sensor.

Referring to FIG. 4, when the fire suppression system 100 for automatically tracking an ignition point according to an embodiment of the present disclosure operates such that the ultraviolet ray sensor 121 of the automatic ignition point tracking detection module 120 detects ultraviolet rays emitted from the flame of the monitoring target area, the ultraviolet ray sensor 121 transmits the fire detection signal to the controller 130.

When the fire detection signal is transmitted from the ultraviolet-ray sensor 121 to the controller 130, the controller 130 operates the first and second ultraviolet ray sensors to detect infrared rays generated from the flame, and double-check whether the fire has occurred.

When the UV light is sensed by the UV sensor 121 and the IR light is sensed by the first and second IR sensors 122 and 123, the controller 130 transmits a danger detection signal to the control center 210 or the manager terminal 220 through the communication unit 140 so that a manager may monitor whether a fire has occurred in the monitoring target area.

In this regard, the first infrared-ray sensor 122 detects the infrared detection position in the horizontal direction and transmits the detected position to the ignition point coordinate calculator 124. The second infrared-ray sensor 123 detects the infrared detection position in the vertical direction and transmits the detected position to the ignition point coordinate calculator 124.

In addition, the ignition point coordinate calculator 124 calculates the coordinates of the ignition point S based on the infrared detection positions transmitted from the first and second ultraviolet-ray sensors 122 and 123 and transmits the calculated coordinates to the controller 130. In response thereto, the controller 130 rotates the casing 111 in the horizontal direction and simultaneously pivots the ejection nozzle 112 in the vertical direction based on the coordinates of the ignition point S to direct the ejection nozzle toward the ignition point S.

As described above, when the ejection nozzle 112 is directed toward the ignition point S, the thermal imaging camera 125 acquires a thermal image of the monitoring target area and measures the temperature of the ignition point S, and thus detects whether a fire has occurred in the monitoring target area once more.

In this regard, when the temperature of the ignition point S detected in the thermal image obtained by the thermal imaging camera 125 is lower than the threshold temperature, the thermal imaging camera 125 determines that no fire has occurred and transmits a fire re-detection request signal to the controller 130 to repeat the above-described process to detect whether a fire has occurred in the monitoring target area.

To the contrary, when the temperature of the ignition point S detected in the thermal image obtained by the thermal imaging camera 125 is higher than or equal to the threshold temperature, the thermal imaging camera 125 determines that the fire is the real fire and transmits the fire extinguishing agent ejection signal to the controller 130 so that the opening/closing valve 114 is opened by the controller 130. Thus, the fire extinguishing agent is ejected to the ignition point S through the ejection nozzle 112, thereby rapidly suppressing the fire.

In addition, the thermal image acquired by the thermal image camera 125 is transmitted to the control center 210 or the manager terminal 220 through the communication unit 140 so that the manager may monitor the thermal image.

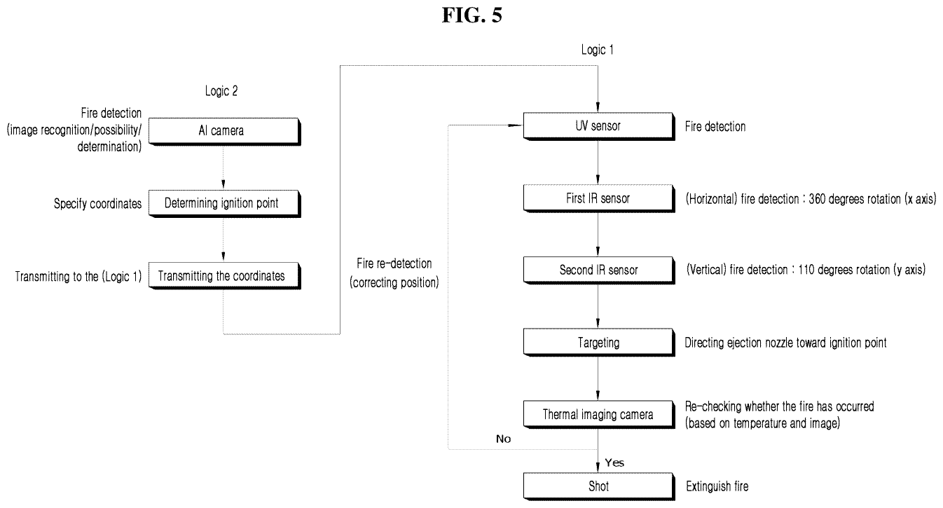

FIG. 5 is a flowchart illustrating a process of suppressing a fire when a fire in a monitoring target area is detected by an AI camera.

Referring to FIG. 5, when a fire is detected through a real image of a monitoring target area obtained by the AI camera 126 in a state in which a fire is not detected by the ultraviolet-ray sensor 121, the first and second ultraviolet-ray sensors 122 and 123, and the thermal imaging camera 125, the AI camera 126 analyzes a real image of an ignition point to determine whether a real fire has occurred. When it is determined that the real fire has occurred, the AI camera 126 calculates coordinates of the ignition point S and transmits the calculated coordinates to the controller 130.

In this case, the controller 130 transmits a danger detection signal to the control center 210 or the manager terminal 220 through the communication unit 140, and the AI camera 126 transmits the real image of the monitoring target area to the control center 210 or the manager terminal 220 through the communication unit so that the manager may monitor the real image.

When the coordinates of the ignition point are transmitted from the AI camera 126 to the controller 130, the controller 130 operates the ultraviolet-ray sensor 121 and the first and second infrared-ray sensors 122 and 123 to re-detect whether a fire has occurred at the ignition point S.

In this regard, when the infrared detection position detected as the first and second infrared-ray sensors 122 and 123 operate is transmitted to the ignition point coordinate calculator 124, the ignition point coordinate calculator 124 re-calculates the ignition point S coordinate, and transmits the re-calculated coordinates to the controller 130, so that the casing 111 and the ejection nozzle 112 are respectively rotated and pivoted based on the ignition point S coordinate re0calculated by the ignition point coordinate calculator 124 to direct the ejection nozzle toward the ignition point S.

Thereafter, the thermal imaging camera 125 acquires the thermal image of the monitoring target area again, re-measures the temperature of the ignition point S, determines that the fire is a real fire only when the temperature of the ignition point S in the thermal image is equal to or higher than the threshold temperature. Then, upon determination that the fire is the real fire, the thermal imaging camera 125 transmits the fire extinguishing agent ejection signal to the controller 130. Thus, the controller controls the opening/closing valve 114 to be opened, so that the fire extinguishing agent is sprayed to the ignition point S through the ejection nozzle 112 to quickly extinguish the fire.

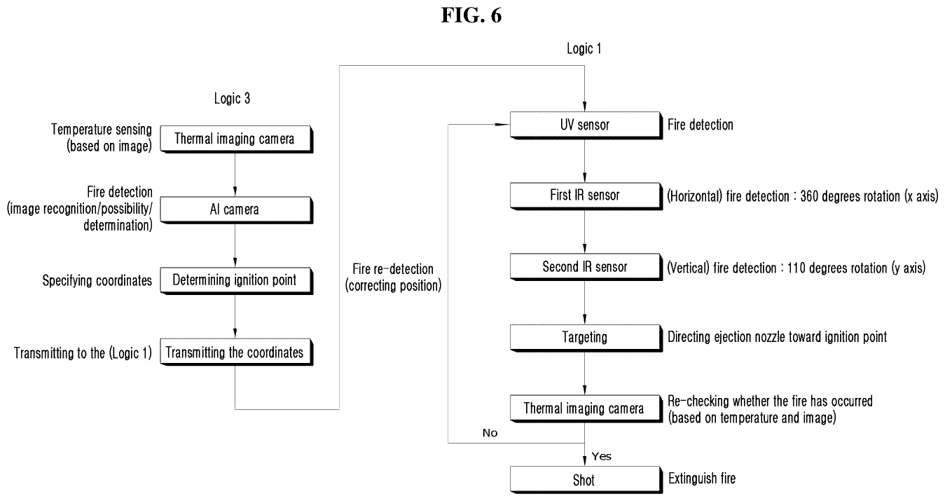

FIG. 6 is a flowchart illustrating a process of suppressing a fire when a fire in a monitoring target area is detected by a thermal imaging camera.

Referring to FIG. 6, when the temperature of the ignition point S detected in the thermal image of the monitoring target area obtained by the thermal imaging camera 125 is higher than or equal to the threshold temperature in a state in which a fire is not detected by the ultraviolet-ray sensor 121 and the first and second infrared-ray sensors 122 and 123, the AI camera 126 acquires a real image of the ignition point to determine whether a real fire has occurred therein. When it is determined that the real fire has occurred, the AI camera 126 calculates coordinates of the ignition point S and transmits the calculated coordinates to the controller 130.

In this case, the controller 130 transmits the danger detection signal to the control center 210 or the manager terminal 220 through the communication unit 140. Further, the controller 130 transmits the thermal image obtained by the thermal image camera 125 and the real image obtained by the AI camera 126 to the control center 210 or the manager terminal 220 through the communication unit 140, so that the manager may monitor the thermal image and the real image.

In one example, when the coordinates of the ignition point S is transmitted from the AI camera 126 to the controller 130, the controller operates the ultraviolet-ray sensor 121 and the first and second infrared-ray sensors 122 and 123 to re-detect whether a fire has occurred at the ignition point S.

In this regard, when the infrared detection position detected as the first and second infrared-ray sensors 122 and 123 operate is transmitted to the ignition point coordinate calculator 124, the coordinates of the ignition point S are recalculated by the ignition point coordinate calculator 124, which in turn transmits the coordinates of the ignition point to the controller 130. In this response, the controller 130 controls the casing 111 and the ejection nozzle 112 to be respectively rotated and pivoted based on the coordinates of the ignition point S to direct the ejection nozzle 112 toward the ignition point S.

Thereafter, a thermal image of the monitoring target area is obtained again through the thermal imaging camera 125, the temperature of the ignition point S is re-measured by the thermal imaging camera 125. The thermal imaging camera 125 determines that the fire is the real fire only when the temperature of the ignition point S in the thermal image of the monitoring target area is equal to or higher than the threshold temperature. Upon determination that the fire is the rear fire, the fire extinguishing agent ejection signal is transmitted from the thermal imaging camera 125 to the controller 130, so that the opening/closing valve 114 is opened by the controller 130 to eject the fire extinguishing agent to the ignition point S through the ejection nozzle 112, thereby rapidly suppressing the fire.

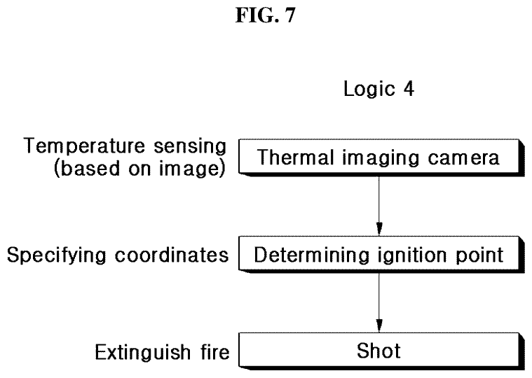

FIG. 7 is another flowchart illustrating a process of suppressing a fire when a fire in a monitoring target area is detected by a thermal imaging camera.

Referring to FIG. 7, when the temperature of the ignition point S in the thermal image of the monitoring target area obtained by the thermal imaging camera 125 is higher than or equal to the threshold temperature in a state in which a fire is not sensed by the ultraviolet-ray sensor 121 and the first and second infrared-ray sensors 122 and 123, the thermal imaging camera 125 calculates the coordinates of the ignition point S and transmits the calculated coordinates to the controller 150.

In this case, the controller 130 transmits the danger detection signal to the control center 210 or the manager terminal 220 through the communication unit 140. Further, the controller 130 transmits the thermal image obtained by the thermal image camera 125 to the control center 210 or the manager terminal 220 through the communication unit 140 so that the manager may monitor the thermal image.

When the coordinates of the ignition point S is transmitted to the controller 130, the controller 130 rotates the casing 111 pivots the ejection nozzle 112 based on the coordinates of the ignition point S to direct the ejection nozzle 112 toward the ignition point S, and then opens the opening/closing nozzle 114 to allow the fire extinguishing agent to be ejected to the ignition point S through the ejection nozzle 112 so that the fire can be quickly extinguished.

As described above, the fire suppression system 100 for automatically tracking an ignition point according to an embodiment of the present disclosure detects whether a fire has occurred in a monitoring target area in real time using the automatic ignition point tracking detection module 120, tracks the ignition point S, and quickly and accurately determines whether a real fire has occurred at the detected ignition point S, and ejects the fire extinguishing agent to the ignition point S in an accurate manner, thereby quickly suppressing the fire in the early stage.

For example, the smoke is not detected and ultraviolet rays or infrared rays are not detected at the ignition point at an initial timing of the fire event in which a only small burning piece of a material is alive without generating flames or smoke. In this case, the fire is not detected by a general camera, an ultraviolet-ray sensor, or a fire monitoring system using an infrared-ray sensor, and thus it is difficult to extinguish the fire in the initial stage of the fire.

However, in the fire suppression system 100 for automatically tracking an ignition point according to an embodiment of the present disclosure, even in the initial stage of the fire in which the flame or smoke as detected by the UV sensor 121 or the first and second IR sensors 122 and 123 is not yet generated, and only a small burning piece is alive, the ignition point S at which the temperature is higher than or equal to the threshold temperature is detected by the thermal imaging camera 125. Thus, the ejection nozzle 121 is directed toward the ignition point S to eject the fire extinguishing agent thereto, thereby quickly suppressing the fire in the initial stage.

In addition, even in the case of a flame occurring event in which a fire is not detected by the ultraviolet-ray sensor 121, the first and second infrared-ray sensors 122 and 123, and the thermal imaging camera 125, or in the early stage of the fire in which only smoke is blooming while the ignition point S at which the temperature is higher than or equal to the threshold temperature is not detected by the thermal imaging camera 125, the smoke can be detected based on the real image obtained by the AI camera 126 to quickly detect and track the ignition point S. Thus, the ejection nozzle 121 is directed toward the ignition point S to eject the fire extinguishing agent thereto, thereby quickly suppressing the fire in the initial stage.

As described above, the fire suppression system 100 for automatically tracking an ignition point according to an embodiment of the present disclosure is capable of detecting the fire occurrence in the monitoring target area in a multiple checking manner in response to various initial fire occurrence conditions. Thus, even at the beginning of the fire occurrence at which it is difficult to detect the fire occurrence, the ignition point S is quickly and accurately detected and tracked. Thus, when it is determined that the real fire has occurred, the ejection nozzle 121 is accurately directed to the ignition point and ejects the fire extinguishing agent thereto, thereby being capable of quickly suppressing the fire in the early stages of the fire.

Although the present disclosure has been described with reference to the accompanying drawings, the present disclosure is not limited by the embodiments disclosed herein and the drawings, and it is obvious that various modifications may be made by those skilled in the art within the scope of the technical idea of the present disclosure. In addition, although the effects based on the configuration of the present disclosure are not explicitly described and illustrated in the description of the embodiment of the present disclosure above, it is obvious that predictable effects from the configuration should also be recognized.

What is claimed is:

1. A fire suppression system for automatically tracking an ignition point, the system comprising:
a fire extinguishing agent spraying module comprising:
a casing installed to be rotatable in a horizontal direction in a monitoring target area; and
an ejection nozzle installed on the casing to be pivotable in a vertical direction and configured to eject a fire extinguishing agent to a fire occurrence point in the monitoring target area,
an automatic ignition point tracking detection module disposed close to the ejection nozzle and configured to detect whether a fire has occurred in the monitoring target area and to calculate coordinates of an ignition point; and
a controller configured to rotate the casing and pivot the ejection nozzle based on the coordinates of the ignition point calculated by the automatic ignition point tracking detection module such that the ejection nozzle is directed toward the ignition point, and ejects the fire extinguishing agent to the ignition point.

2. The fire suppression system for automatically tracking the ignition point of claim 1, wherein the casing is rotatable in the horizontal direction by a first driving motor controlled by the controller,
wherein the ejection nozzle is pivotable in the vertical direction by a second driving motor controlled by the controller and is configured to eject the fire extinguishing agent, wherein the fire extinguishing agent spraying module further comprises:
a fire extinguishing agent storage tank connected to the ejection nozzle via a fire extinguishing agent supply line and configured to supply the fire extinguishing agent stored therein to the ejection nozzle via the fire extinguishing agent supply line; and
an opening and closing valve installed at the fire extinguishing agent supply line, wherein when a fire occurrence signal is transmitted from the automatic ignition point tracking detection module to the controller, the opening and closing valve is configured to be opened by the controller such that the fire extinguishing agent stored in the fire extinguishing agent storage tank is fed to the ejection nozzle via the fire extinguishing agent supply line and then is ejected to the ignition point through the ejection nozzle.

3. The fire suppression system for automatically tracking the ignition point of claim 1, wherein the automatic ignition point tracking detection module comprises:
an ultraviolet-ray sensor disposed close to the ejection nozzle and configured to detect ultraviolet rays emitted from a flame in the monitoring target area and to transmit a fire detection signal to a controller;
first and second infrared-ray sensors configured to detect infrared rays generated from the flame when the fire detection signal has been transmitted from the ultraviolet-ray sensor to the controller, to detect whether a fire has occurred in the monitoring target area in a double manner based on the detected infrared rays, and to detect an infrared detection position based on the detected infrared rays;
an ignition point coordinate calculator configured to calculate coordinates of the ignition point based on the infrared detection position detected from the first and second infrared-ray sensors and to transmit the calculated coordinates to the controller, wherein the controller is configured to rotate the casing and pivot the ejection nozzle based on the coordinates of the ignition point such that the ejection nozzle is directed toward the ignition point; and
a thermal imaging camera disposed close to the ejection nozzle and configured to acquire a thermal image of the monitoring target area, to measure a temperature of the monitoring target area, and to detect whether a fire has occurred in the monitoring target area, based on the measured temperature.

4. The fire suppression system for automatically tracking the ignition point of claim 3, wherein when the casing and the ejection nozzle of the fire extinguishing agent spraying module are respectively rotated and pivoted based on the coordinates of the ignition point as calculated by the ignition point coordinate calculator such that the ejection nozzle is directed toward the ignition point,
the thermal imaging camera is configured to:
acquire a thermal image of the ignition point; and
only upon determination that the temperature of the ignition point in the thermal image is higher than or equal to a threshold temperature, determine that the fire is a real fire, and transmit a fire extinguishing agent ejection signal to the controller.

5. The fire suppression system for automatically tracking the ignition point of claim 3, wherein when a temperature of the ignition point in the obtained thermal image of the monitoring target area is higher than or equal to a threshold temperature in a state in which a fire is not sensed by the ultraviolet-ray sensor and the first and second infrared-ray sensors, the thermal imaging camera is configured to calculate coordinates of the ignition point and transmit the calculated coordinates to the controller, wherein the controller is configured to rotate the casing and pivot the ejection nozzle based on the coordinates of the ignition point such that the ejection nozzle is directed toward the ignition point and ejects the fire extinguishing agent to the ignition point.

6. The fire suppression system for automatically tracking the ignition point of claim 3, wherein the automatic ignition point tracking detection module further comprises an artificial intelligence (AI) camera disposed close to the ejection nozzle and configured to acquire a real image of the monitoring target area and to detect whether a fire has occurred in the monitoring target area based on the real image.

7. The fire suppression system for automatically tracking the ignition point of claim 6, wherein when a temperature of the ignition point in the obtained thermal image of the monitoring target area is higher than or equal to a threshold temperature in a state in which a fire is not sensed by the ultraviolet-ray sensor and the first and second infrared-ray sensors,
the AI camera is configured to:
acquire a real image of the ignition point, determine whether a fire is a real fire based on the real image; and
upon determination that the real fire has occurred, calculate coordinates of the ignition point are and transmit the calculated coordinates to the controller, wherein when the coordinates of the ignition point is transmitted from the AI camera to the controller, the controller is configured to operate the ultraviolet-ray sensor and the first and second infrared-ray sensors to re-detect whether a fire has occurred at the ignition point,
wherein the infrared detection position detected as the first and second infrared-ray sensors operates is transmitted to the ignition point coordinate calculator, wherein the ignition point coordinate calculator is configured to recalculate the ignition point coordinates, and transmit the recalculated ignition point coordinates to the controller, wherein the controller is configured to rotate the casing and pivot the ejection nozzle based on the recalculated ignition point coordinates to direct the ejection nozzle toward the ignition point,
wherein the thermal imaging camera is configured to re-acquire a thermal image of a monitoring target area, re-measure a temperature of the ignition point, determine the fire as a real fire only when the temperature of the ignition point is higher than or equal to a threshold temperature, and transmit a fire extinguishing agent ejection signal to the controller upon determination that the fire is the real fire, wherein the controller controls the ejection nozzle to eject the fire extinguishing agent to the ignition point in response to the fire extinguishing agent ejection signal.

8. The fire suppression system for automatically tracking the ignition point of claim 6, wherein when a fire is detected based on the real image of the monitoring target area obtained by the AI camera in a state in which a fire is not detected by the ultraviolet-ray sensor, the first and second infrared-ray sensors, and the thermal imaging camera,
the AI camera is configured to:
analyze the real image of the ignition point and determine whether the fire is a real fire based on the analysis result;
upon determination that the real fire has occurred, calculate coordinates of the ignition point and transmit the calculated coordinates to the controller, wherein when the coordinates of the ignition point is transmitted from the AI camera to the controller, the controller is configured to operate the ultraviolet-ray sensor and the first and second infrared-ray sensors to re-detect whether a fire has occurred at the ignition point,
wherein the infrared detection position detected as the first and second infrared-ray sensors operates is transmitted to the ignition point coordinate calculator, wherein the ignition point coordinate calculator is configured to calculate the ignition point coordinates, and transmit the calculated ignition point coordinates to the controller, wherein the controller is configured to rotate the casing and pivot the ejection nozzle based on the calculated ignition point coordinates to direct the ejection nozzle toward the ignition point,
wherein the thermal imaging camera is configured to re-acquire a thermal image of a monitoring target area, re-measure a temperature of the ignition point, determine the fire as a real fire only when the temperature of the ignition point is higher than or equal to a threshold temperature, and transmit a fire extinguishing agent ejection signal to the controller upon determination that the fire is the real fire, wherein the controller controls the ejection nozzle to eject the fire extinguishing agent to the ignition point in response to the fire extinguishing agent ejection signal.

9. The fire suppression system for automatically tracking the ignition point of claim 1, wherein upon determination that a distance from the ejection nozzle to the ignition point is within a preset distance, the controller is configured to control the ejection nozzle to spray the fire extinguishing agent to the ignition point in a shower manner,
wherein upon determination that the distance from the ejection nozzle to the ignition point is out of the preset distance, the controller is configured to control the ejection nozzle to eject the fire extinguishing agent to the ignition point in a shooting manner.

10. The fire suppression system for automatically tracking the ignition point of claim 3, wherein the automatic ignition point tracking detection module further comprises a dust-proof means configured to periodically operate every time interval set by the controller to remove dusts accumulated on a surface of each of the ultraviolet-ray sensor and the first and second infrared-ray sensors and a lens of each of the thermal imaging camera and the AI camera.
